(19) United States
(12) Patent Application Publication
(10) Pub. No.: US 2006/0013417 A1
(43) Pub. Date: Jan. 19, 2006

(54) Acoustical panel assembly

(75) Inventors: Thomas G. Bailey, Highland, MI (US); Scott W. Freeman, Fenton, MI (US); Tom Heiman, Dansville, MI (US); Victor C. Evjen, Highland, MI (US)

Correspondence Address: HONIGMAN MILLER SCHWARTZ AND COHN LLP, 32270 TELEGRAPH RD, SUITE 225, BINGHAM FARMS, MI, 48025-2457, US

(73) Assignee: Intier Automotive Inc.

(21) Appl. No.: 11/179,439

(22) Filed: Jul. 12, 2005

Related U.S. Application Data
(60) Provisional application No. 60/588,872, filed on Jul. 16, 2004.

(51) Int. Cl. H04R 25/00

(52) U.S. Cl. 381/152; 381/425

(57) ABSTRACT

An acoustical panel assembly (10) includes a panel (12) having a core (13) made of synthetic material and an acoustical device (26) mounted to an exterior surface (14, 16) of the panel (12). The panel (12) may include an integrally formed attachment member (24) for mounting the acoustic device (26), such as a loudspeaker, an exciter, a piezoelectric transducer, or the like, directly to the panel (12) without the need of a separate mounting member. Alternatively, the acoustic device (26) may be mounted directly to the panel (12) without the use of the attachment member (24). The panel (12) can be formed by a reaction injection molding (RIM) process, a reinforced reaction injection molding (RRIM) process, or a structural reaction injection molding (SRIM) process.

### CROSS REFERENCE TO RELATED APPLICATIONS

This application claims the benefit of U.S. Provisional Application No. 60/588,872, filed Jul. 16, 2004, which is incorporated herein by reference in its entirety.

### BACKGROUND OF THE INVENTION

1. Field of the Invention

The invention relates in general to an acoustical panel assembly, and in particular to an acoustical panel assembly comprising a panel made of a material formed by a reaction injection molding (RIM) process, a reinforced reaction injection molding (RRIM) process, or a structural reaction injection molding (SRIM) process with an acoustic device, such as a loudspeaker, an exciter, a piezoelectric transducer, and the like, mounted thereon.

2. Description of the Related Art

Traditionally, auto manufacturers have made sole use of traditional cone speakers that have a minimum depth requirement that has demanded a minimum packaging space. This requirement has ensured that audio speaker placement has often been determined not by optimum in-car sound quality, but by available space. Thus, most vehicles audio speakers are tucked away down by the occupants' knees and not necessarily located for optimum listening.

An acoustic device, such as a piezoelectric transducer, an electrodynamic device, a flat panel loudspeaker, distributed mode loudspeaker (DML), and the like, applies bending wave energy to a panel to cause the panel to resonate and produce an acoustic output (i.e., sound). One such acoustic device is commercially available from New Transducers Limited (NXT™) of Huntingdon, England. A typical electrodynamic device, for example, comprises a magnet assembly rigidly fixed to a housing to define an annular gap, and a voice coil and coil former assembly disposed in the annular gap and rigidly fixed to the panel near to the geometric center thereof.

Typically, the acoustic device is mounted to the panel by using a separate mounting member, such as a mounting plate, that is fixedly attached to the panel using one or more fasteners, such as screws, adhesives, double-side tape, or the like. After the separate mounting member is fixedly attached to the panel, the acoustic device can be fixedly attached to the panel via the mounting member.

It has been found that a suitable conventional material for the panel that will produce an acceptable frequency response is made of an extremely low-density, rigid plastic foam material commercially available under the tradename ROHACELL® sold by Roehm GMBH Limited located in the Fed. Rep. of Germany. ROHACELL® is a polymethacrylimide (PMI) hard foam, that is used as a core material for sandwich constructions. For example, ROHACELL® is typically used as a modeling material for architects and sculptors, and in some cases, as a building insulation. ROHACELL® is available with densities ranging from 2.0 to 6.87 lbs/ft³ (32 to 110 kg/m³). However, such a material may not have the necessary structural properties, such as stiffness, rigidity, and the like, that is suitable for use in most home, office and/or automotive applications, such as for use in vehicular door panels, instrument panels, trim panels, residential and commercial floor and ceiling panels, and the like.

### SUMMARY OF THE INVENTION

The inventors of the present invention have recognized these and other problems associated with conventional materials used for panels that resonate and produce an acoustic output, while providing the structural characteristics that are suitable for automotive applications. To this end, the inventors have developed a material for use as a panel made of a material formed by a Reaction Injection Molding (RIM) process, a Reinforced Reaction Injection Molding (RRIM) process, or a Structural Reaction Injection Molding (SRIM) process that can widely be used in automotive applications, and unexpectedly produces an acceptable acoustic output when the acoustic device is mounted thereon.

In an embodiment of the invention, an acoustical panel assembly comprises a panel having a core made of synthetic material comprising a mixture of isocynate and polyol, and an acoustic device mounted to an exterior surface of the panel.

In another embodiment of the invention, an acoustical panel assembly comprises a core made of a synthetic material having a specific gravity in a range between about 0.1 and 1.4, and an acoustic device mounted to an exterior surface of the core.

In a method of the invention, the method comprises the steps of forming a panel comprising a core made of a synthetic material by one of a reaction injection molding (RIM) process, a reinforced reaction injection molding (RRIM) process, and a structural reaction molding (SRIM) process, and mounting an acoustic device to the panel.

### BRIEF DESCRIPTION OF THE DRAWINGS

In the drawings:

FIG. 1 shows a front perspective view of an acoustical panel assembly comprising a panel comprising a core with an acoustic device mounted on an exterior surface of the panel according to an embodiment of the invention;

FIG. 2 is a cross-sectional view of the panel comprising a core having reinforcing fibers taken along line 2-2 of FIG. 1;

FIG. 3 is a cross-sectional view of the panel comprising a core having a fiberglass mat embedded therein taken along line 2-2 of FIG. 1;

FIG. 4 is a cross-sectional view of the panel comprising a core and a scrim material on one exterior surface of the core taken along line 2-2 of FIG. 1;

FIG. 5 is a cross-sectional view of the panel comprising a core and a cover material and a layer of foam between the cover material and the core taken long line 2-2 of FIG. 1;

FIG. 6 shows a side view of the acoustical panel assembly of FIG. 1 with an integrally formed attachment member and acoustical device mounted to the panel;

FIG. 7 shows perspective view of the inner surface of the acoustical panel assembly of FIG. 6;

FIG. 8 shows a partial side view of the acoustical panel assembly with an attachment member integrally formed therewith according to another embodiment of the invention;

FIG. 9 is a flow chart diagram illustrating a method of manufacturing the panel according to one embodiment of the invention;

FIG. 10 is a graph of the frequency response for a 30 cm square RIM panel without any reinforcement and having a thickness of approximately 10 mm when the acoustic device is mounted at a location directly at the center of the panel; and

FIG. 11 is a graph of the frequency response for a 30 cm square conventional ROHACELL® panel having a thickness of approximately 10 mm when the acoustic device is mounted at a location directly at the center of the panel.

### DESCRIPTION OF THE PREFERRED EMBODIMENT

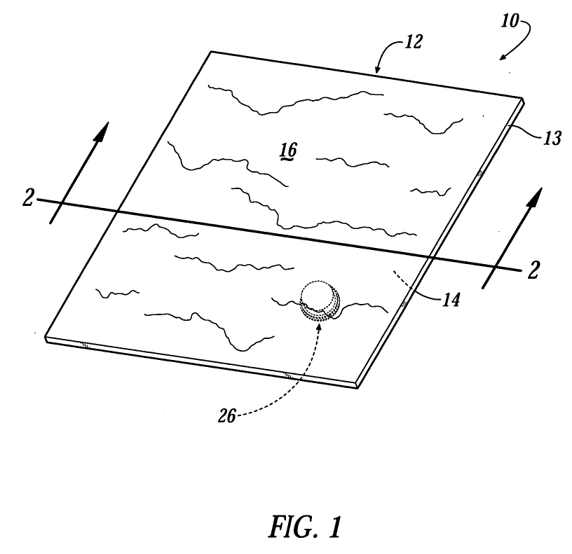

Referring to FIGS. 1-4, an acoustical panel assembly 10 includes a panel 12. For automotive applications, for example, the panel 12 may be in the form of a vehicular headliner, door panel, valence panel, dashboard, package tray, or the like. For residential and commercial applications, the panel 12 may be in the form of floor or ceiling panel. For example, the panel 12 may form a door panel in which one exterior surface forms a Class “B” surface that faces away from the interior of the vehicle and is not visible to the occupants, and the opposed exterior surface forms a Class “A” surface that faces the interior of the vehicle and is visible to the occupants.

As shown in FIG. 1, one embodiment of the acoustical panel assembly 10 includes the panel 12 comprising a core 13 made of a synthetic material of unitary construction having an inner surface 14 and an outer surface 16. The synthetic material may comprise, for example, a mixture of isocynate and polyol by using a RIM process to form the core 13 of the panel 12. However, it will be appreciated that a single, unmixed composition of synthetic material or other mixtures of synthetic materials are within the scope of the invention. In an embodiment in which the synthetic material comprises a mixture of isocynate and polyol in which the ratio of isocynate to polyol is approximately equal to 1.62:1. However, it will be appreciated that other mixture ratios of isocynate and polyol are within the scope of the invention.

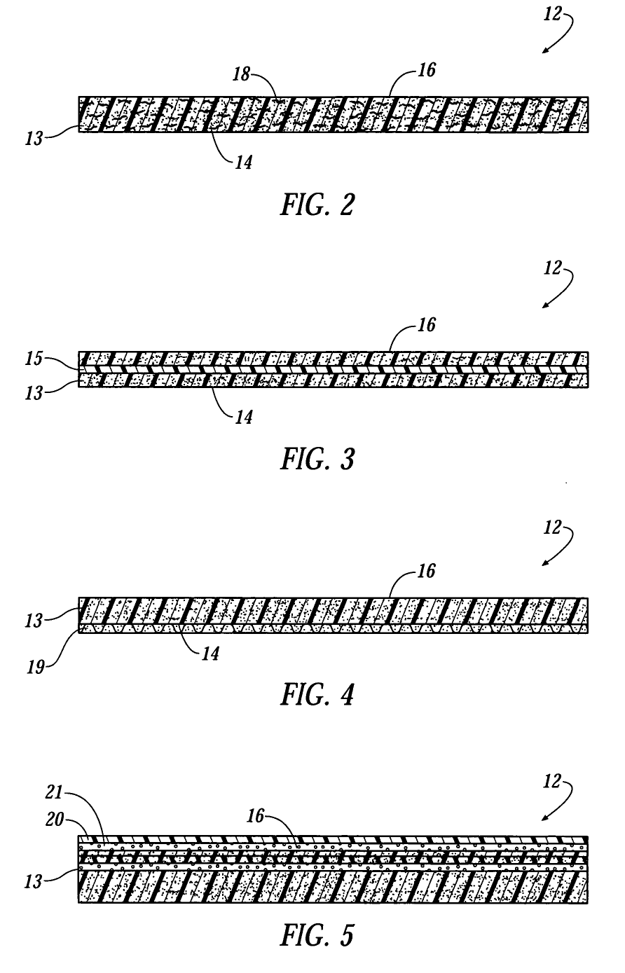

As illustrated in FIG. 2, the panel 12 may also include a reinforcing material encapsulated within the core 13 by using a RRIM process to form the panel 12. The reinforcing material may be any suitable reinforcing material known to those skilled in the art. For example, the reinforcing material may be in the form of reinforcing fibers 18, such as glass fibers, carbon fibers, or the like. The reinforcing fibers 18 may alternatively include natural fibers, such as, for example, hemp fibers, coconut fibers, kanuf fibers, flax fibers, or the like. As illustrated in FIG. 3, the reinforcing material may be in the form of a fiberglass mat 15 encapsulated within the core 13, rather than the reinforcing fibers by using a RRIM process to form the panel 12.

It will be appreciated that the invention can be practiced without the use of the reinforcement material encapsulated in the core 13 of the panel 12. For example, as illustrated in FIG. 4, the core 13 does not include the reinforcing material 18 encapsulated therein, but rather a layer of reinforcing scrim material 19 may be bonded to the inner surface 14 of the core 13. The scrim material 19 can also be bonded to the outer surface 16, or both the inner surface 14 and the outer surface 16 of the core 13. The scrim material 19 may comprise a “combo mat” that includes glass fibers, carbon fibers, or the like, and/or natural fibers, such as, for example, hemp fibers, coconut fibers, kanuf fibers, flax fibers, or the like. The “combo mat” may also include an adhesive material for bonding the “combo mat” to the core 13. The embodiment of the panel 12 having the scrim material 19 on only one exterior surface of the core 13 may by useful in application in which the panel 12 needs a non-planar or curved profile.

As illustrated in FIG. 5, another embodiment of the panel 12 may include a cover 20 bonded to the outer surface 16 of the core 13 to form a decorative “A” surface of the panel 12. The cover 20 may comprise any desirable material, such as, for example, vinyl, acrylic, thermoplastic olefin (TPO), polyethylene terepthalate (PET), cross-linked polyolefin (XLPO), or the like. Alternatively, the cover 20 may comprise a decorative cloth material, or the like. The cover 20 may be bonded or attached to the outer surface 16 of the core 13 by use of an adhesive (not shown), or other suitable means for bonding or attaching the cover 20 to the outer surface 16. If desired, a layer 21 of foam material may be disposed between the cover 20 and the outer surface 16 of the core 13. If desired, the cover 20 may have an embossed appearance for displaying, for example, a manufacturer's logo, or the like. As illustrated, the panel 12 does not include the reinforcing fibers 18 and/or the scrim material 19. However, if desired, the reinforcing material 18 and/or the scrim material 19, as shown in FIGS. 2 and 3, may be included in this embodiment of the panel 12.

It will be appreciated that the panel 12 may comprise any combination of the various layers of materials stated above. For example, the synthetic panel 12 may include a layer of scrim material 19 in the form of a “combo mat” on both the inner and outer surfaces 14, 16 and a cover material 20 bonded to the scrim material 19 on the outer surface 16 to provide a decorative appearance. The cover material 20 may have an embossed appearance, if desired. In another example, the synthetic panel 12 may include the cover material 20 bonded to the outer surface 16 of the core 13 having a fiberglass mat 15 encapsulated therein. Other combinations of layers of materials are within the scope of the invention.

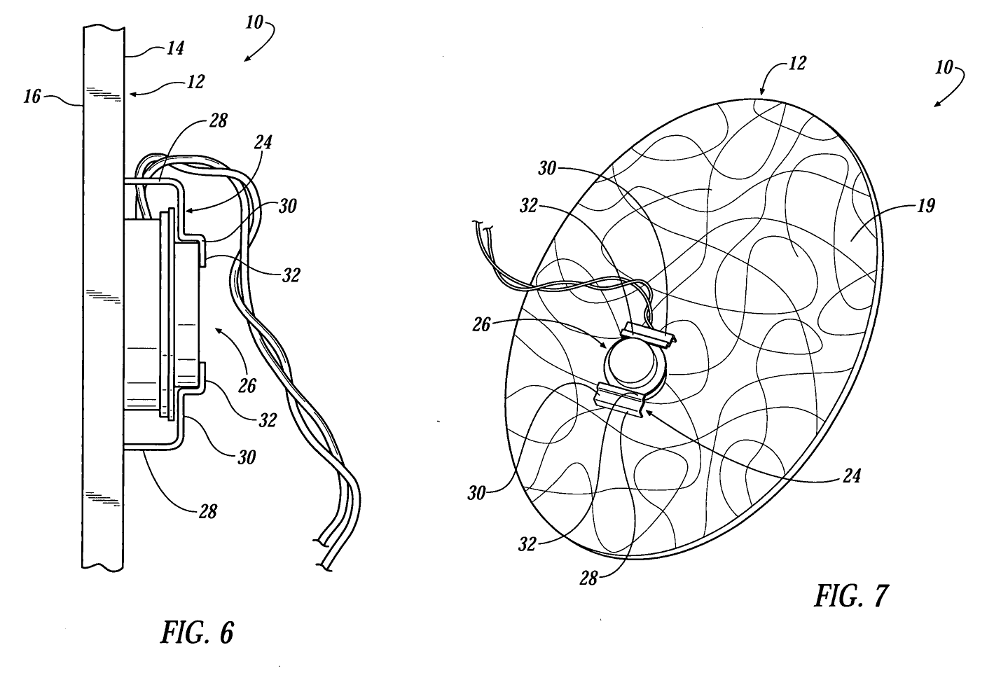

Referring now to FIGS. 6 and 7, the acoustical panel assembly 10 may include an attachment member 24 for attaching an acoustic device 26, such as a loudspeaker, an exciter, a piezoelectric transducer, or the like, to the acoustical panel assembly 10. One aspect of the invention is that the attachment member 24 is integrally formed with the panel 12 using known molding techniques, such as injection molding, or the like. For example, the attachment member 24 can be integrally formed with the panel 12 by using slides in a mold tool (not shown) that forms the panel 12. Preferably, the attachment member 24 is integrally formed with the panel 12 at a location of the panel 12 that has a substantially flat topography to accommodate the substantially flat profile of the acoustic device 26. However, the invention is not limited by the location at which the acoustic device 26 is mounted to the panel 12. Because the attachment member 24 is integrally formed with the panel 12, the inner and outer surfaces 14, 16 can be generally continuous, unlike conventional mounting systems in which an opening may be necessary for mounting a conventional acoustic device, such as a cone speaker.

In the illustrated embodiment, the attachment member 24 includes a pair of opposing, substantially identical mounting portions 28. Each mounting portion 28 is generally L-shaped in cross section having a lower mounting portion 30 and an upper mounting portion 32 that generally conform to shape of the outer surface of the acoustic device 26. To install the acoustic device 26 to the panel 12, the acoustic device 26 is aligned with the attachment member 24 such that the lower mounting portion 30 and the upper mounting portion 32 are aligned with the acoustic device 26. As the acoustic device 26 is moved toward the attachment member 24, the lower mounting portion 30 and the upper mounting portion 32 flex slightly outward to allow the acoustic device 26 to be inserted into the attachment member 24. Once the acoustic device 26 is fully inserted within the attachment member 24, the lower mounting portion 30 and the upper mounting portion 32 flex inwardly and press against the acoustic device 24 to positively secure the acoustic device 24 against the inner surface 14 of the panel 12.

It will be appreciated that the integrally formed attachment member 24 does not require a separate mounting plate for mounting the acoustic device 26 to the panel 12, unlike conventional mounting devices, thereby eliminating the need for holes in the panel 12 for attaching the separate mounting plate to the panel. Thus, the integrally formed attachment member 24 provides a more aesthetic Class “A” surface than conventional attachment members.

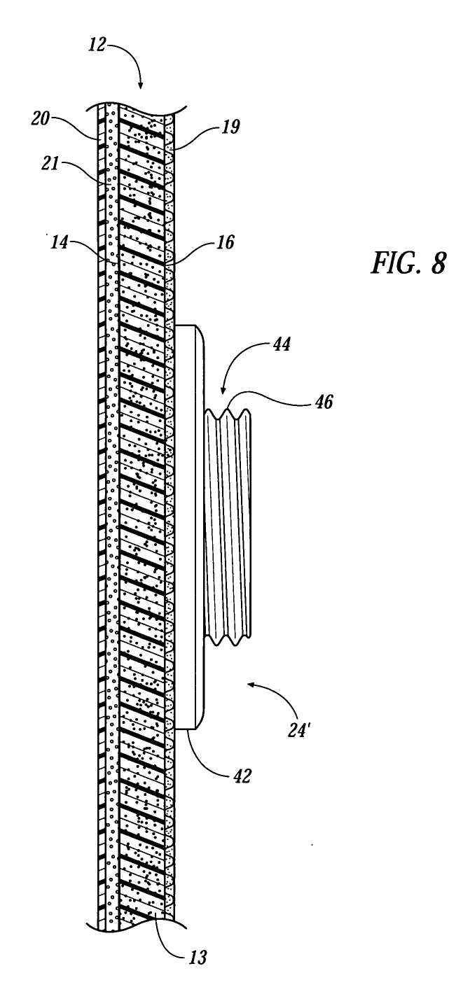

In addition, it will be appreciated that the invention is not limited by the type of attachment member that is integrally formed with the panel 12. For example, an attachment member 24′ may comprise a single piece of plastic material having a base portion 42 and an attachment portion 44 having a plurality of threads 46, as shown in FIG. 8. The attachment member 24′ can be integrally formed with the panel 12 by placing the base portion 42 onto the mold tool prior to injecting the synthetic material into the mold tool. During the injection process, the synthetic material encapsulates the base portion 42, while leaving the attachment portion 44 accessible for mounting the acoustic device 26. The acoustic device 26 can be mounted to the attachment portion 44 by threading the acoustic device 26 onto the attachment portion 44.

It will be appreciated that it is possible to mount the acoustic device 26 directly to the panel 12 without the need for the attachment member 24, 24′ by using an adhesive, or the like.

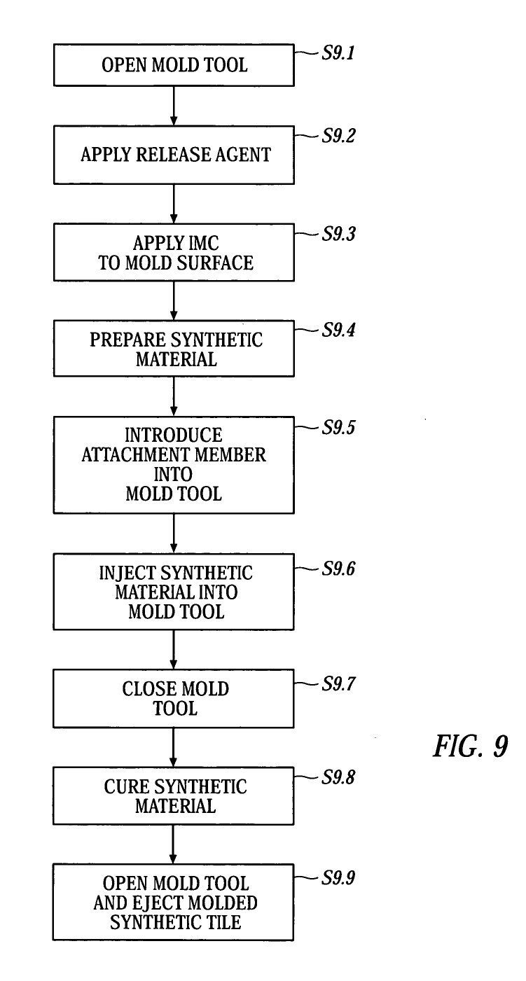

Referring to FIG. 9, a method for manufacturing the panel 12 by using a RIM process is described. At step S9.1, the mold tool (not shown) is opened. Optionally, at step S9.2, a release agent is applied by adding the in-mold release (IMR) agent to the mixture and/or by applying the external mold release (EMR) agent to one or both mold surfaces of the mold tool to assist in releasing the panel 12 from the mold tool upon completion of the mold cycle. Then, if desired, at step S9.3, an optional in-mold coating (IMC) is applied to a surface of the mold tool to provide a decorative surface finish to the panel 12. The decorative surface finish may include any desirable aesthetic appearance with multiple colors or designs, such as streaking, splattering, pad printing, clouding, stone, marble, or the like. If it is determined that the IMC application at step S9.3 is not desired, the desirable aesthetic appearance may be post-applied to the panel 12 upon completion of the mold cycle, if desired.

At step S9.4, the synthetic material is prepared prior to injection into the mold tool at step S9.6. For example, the isocynate and polyol may be separately maintained in a holding tank at a temperature approximately equal to 80° F., and then mixed together at the mixing head or injection nozzle. At step S9.5, the attachment member 24 can be placed onto the opposite surface of the mold tool as the IMC or cover material 20. At step S9.6, the synthetic material is injected in the mold tool. A metered amount of synthetic material may be injected to yield a specific material density of the panel 12. For example, if a higher density of the panel 12 is desired, a relatively larger amount of synthetic material is metered to substantially fill 100% of the volume of the mold tool. According to an embodiment, the synthetic material is injected for 1.9 seconds at a metering rate approximately equal to 300 gram per second (a total of 570 grams of synthetic material) to yield a high density panel 12. As such, when foaming and expansion of the synthetic material occurs, a high density panel 12 may be yielded due to the compression of the synthetic material under tonnage of the closed mold tool. Preferably, a specific gravity of a high-density synthetic material is approximately equal to the range of about 0.60 to about 1.40. It will be appreciated that the invention is not limited by the metered amounts of synthetic material that is injected into the mold tool. For example, the synthetic material can be injected for 1.1 seconds at a metering rate approximately equal to 400 gram per second (a total of 440 grams of synthetic material) to fill a mold tool having dimensions of approximately 25″×25″× 3/16″.

Conversely, the synthetic material may be metered to yield a lower density panel 12 by injecting a relatively smaller amount of synthetic material that is less than 100% of the volume of the mold tool such that the synthetic material, upon injection, is permitted to expand into free space when the mold tool is closed. According to one embodiment of the invention, the synthetic material is injected for approximately 1.0 seconds at a metering rate approximately equal to 300 grams per second to yield a low density panel 12. In an alternative embodiment, a lesser amount of synthetic material may be metered at step S9.6 if a liquid, such as water, and the like, is introduced to the polyol component of the mixture. Upon introducing water to the polyol component, the cellular structure foams at a greater rate, which causes an even lower density of the panel 12. According to one aspect of the invention, a specific gravity of a low-density synthetic material is approximately equal to the range of 0.10 to 0.60.

Upon metering and injecting the synthetic material, the mold tool surface is preferably heated to a temperature in the range approximately equal to 130-190° F. It will be appreciated that the mold tool surface temperature range may include different temperatures depending on the material of the mold tool surface. For example, if the mold tool surface is made of aluminum and is heated to approximately 140° F., the cure time may be approximately 60 sec. to approximately 3 min. At steps S9.7 and S9.8, the mold tool is closed, and the synthetic material is cured to form the core 13 of the panel 12 made of synthetic material of unitary construction. Then, at step S9.9, the mold tool is opened and the panel 12 is removed from the mold tool.

A method for manufacturing the panel 12 by using a RRIM process is similar to the method for manufacturing the panel 12 using the RIM process, except that the reinforcing fibers 18 are introduced into the synthetic material prior to injecting the synthetic material into the mold tool at step S9.6.

Instead of forming the panel 12 using the RRIM process, a method for manufacturing the panel 12 by using a SRIM process is similar to the method for manufacturing the panel 12, except that the scrim material 21 is placed on one or both mold halves of the mold tool prior to injecting the synthetic material into the mold tool at step S9.6.

A method for manufacturing the panel 12 having the cover material 20 can be formed by using the RIM, RRIM or SRIM process described above, except that the decorative cover 20 is introduced onto the surface of the mold tool instead of the IMC at step S9.3, thereby providing a decorative surface finish to the panel 12.

The panel 12 may undergo additional, optional treatment operations once removed from the mold tool. For example, the panel may undergo a power washing step, a drying step, a clear coat application step, a clear coat baking step, and a package and shipping step. The clear coat may be applied in a single or multiple roll coating process steps. The clear coat improves weathering and UV resistance of the panel, especially when used as a floor or wall tile in residential or commercial applications.

It will be appreciated that these additional finishing steps may be omitted when making the final product. For example, if a low density synthetic material is prepared at step S9.4, the finishing procedure may only include an edge trimming operation after being removed from the mold tool. Then, the trimmed panel 12 may be packaged and shipped. In application, the panel 12 may be a ceiling tile applied to a drop ceiling grid (not shown) that is somewhat less rigidified and lighter in weight due to the low density composition of the synthetic material.

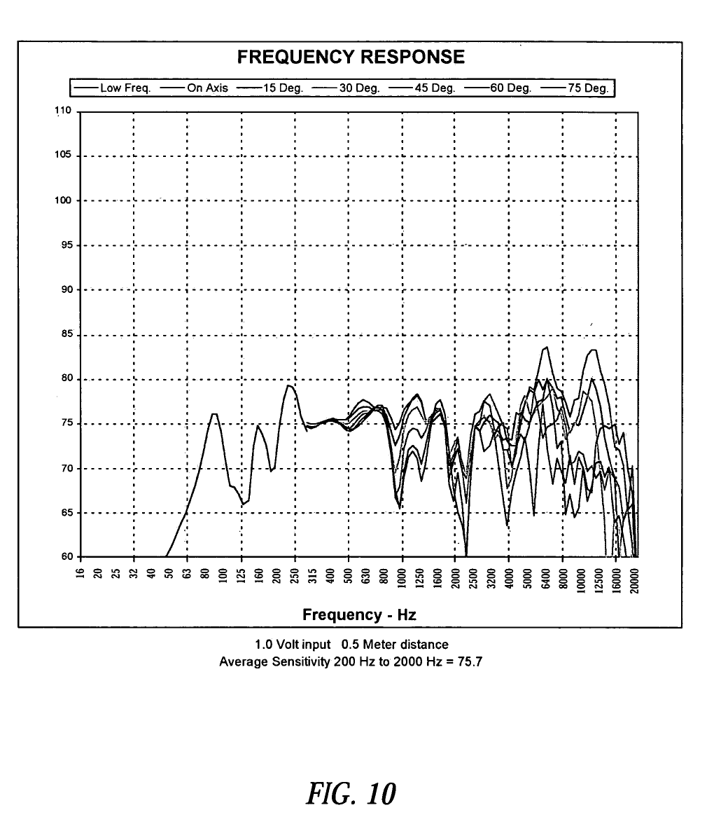

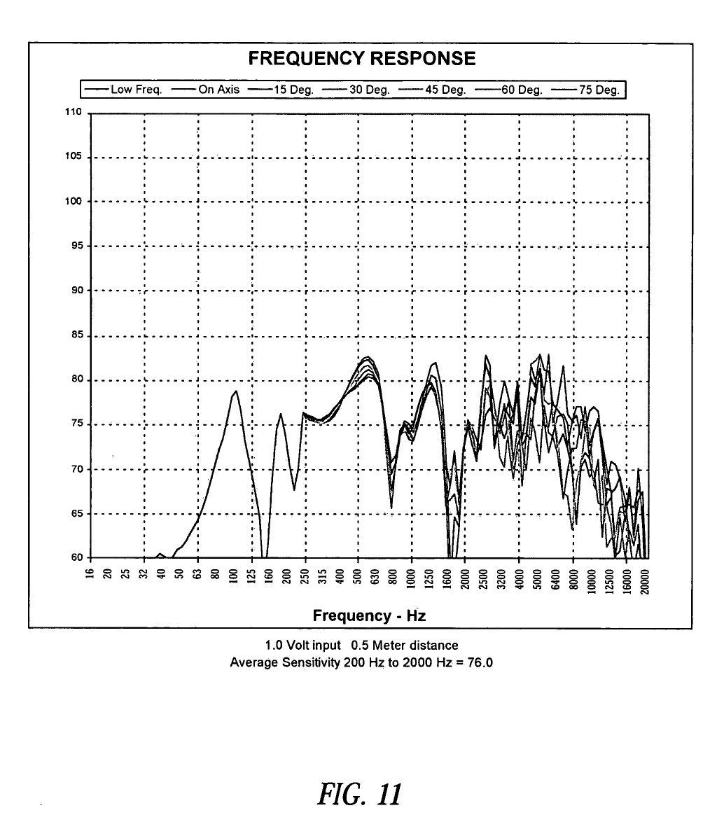

Several tests were conducted with the acoustical panel assembly 10 of the invention, as shown in FIGS. 10 and 11. FIG. 10 shows the frequency response for a covered RIM panel 12 without reinforcement material and with a cover material 20 made of expanded PVC material with a layer of foam 21 between the RIM material and the cover material 20, similar to the panel 12 shown in FIG. 5, and having a thickness of approximately 10 mm. The acoustic device 26 is mounted at the center of the panel 12. FIG. 11 shows the frequency response for a conventional ROHACELL® panel having a thickness of approximately 10 mm when the acoustic device is mounted at a location directly at the center of the panel.

The test results indicated that the best performance of the two tests conducted above was provided by the acoustical panel assembly 10 comprising a covered RIM panel 12 of the invention having no reinforcement material and a cover material made of expanded PVC material with a layer of foam between the RRIM material and the cover material, but when the acoustic device 26 was mounted at a location offset from the center of the panel 12. This result was unexpected because it was believed that the conventional ROHACELL® panel should have provided the best performance based on the wide acceptance of the ROHACELL® panel material for it's acoustical properties when coupled with the acoustic device. However, the inventors have discovered, rather unexpectedly, that the material for the panel 12 produced by the SRIM process produced acceptable acoustical properties, and that the material for the panel 12 produced by the RIM process, and especially the panel 12 that was covered with expanded PVC and a layer of foam therebetween, produced exceptional acoustical performance. By discovering such an expected result, the inventors have discovered that the panel 12 produces superior acoustical properties, while providing the structural properties required for most automotive applications, such as for interior trim panels, and the like.

Another unexpected result discovered by the inventors is that better sound performance is achieved by mounting the acoustic device 26 not directly at the center of the panel 12, but slightly offset from the center location. Specifically, the location for the acoustic device 26 for a rectangular or square-shaped panel can be obtained according to the following equation:
Location=( 4/9)X, ( 3/7)Y
where,
X is the dimension of the panel along the x-axis, and
Y is the dimension of the panel along the y-axis.

For example, the location for the acoustic device 26 for a panel 12 having an x-dimension of 18 cm and a y-dimension of 14 cm would be 8 cm along the x-dimension and 6 cm along the y-dimension. In other words, the optimum location would be 1 cm offset from the center location (9 cm along the x-direction and 7 cm along the y-direction) in both the x- and y-dimensions.

The inventors have also discovered that superior performance is also unexpectedly achieved when the panel 12 of the invention has a core 13 made of low density material that is disposed between two layers of relatively thin, high density material, for example, a thin sheet of aluminum, or the like. In fact, the lower the density of the core 13 and the higher the relative density of the outer surface layers, the better the acoustical performance of the panel 12. For example, it may be desirable that the core 13 be made of the synthetic material that includes voids, but still has the necessary structural properties for use in residential, commercial or automotive applications. For example, the panel 12 may comprise a core 13 having a honeycomb-shaped structure, an I-beam structure, and the like, disposed between layers of a metal, such as aluminum, and the like. The high density layers may be made of a variety of suitable materials, such as paper with or without resin material for bonding to the core, plastic material, glass veil composite skin material, and the like. The thickness of the high density layer may range between about 3 mm to about 5 mm. Other geometrically-shaped structures having the necessary structural properties and made of the synthetic material are within the scope of the invention.

While the invention has been specifically described in connection with certain specific embodiments thereof, it is to be understood that this is by way of illustration and not of limitation, and the scope of the appended claims should be construed as broadly as the prior art will permit.

What is claimed is:

1. An acoustical panel assembly, comprising:
a panel comprising a core made of synthetic material comprising a mixture of isocynate and polyol; and
an acoustic device mounted to an exterior surface of said panel.

2. The panel assembly according to claim 1, wherein said panel comprises a trim panel.

3. The assembly according to claim 1, further comprising an attachment member integrally formed with said panel.

4. The assembly according to claim 1, wherein the panel has a specific gravity in a range between about 0.1 and 1.4.

5. The assembly according to claim 1, wherein said acoustic device is mounted off-center with respect to said panel.

6. The assembly according to claim 1, wherein a ratio of isocyanate to polyol is about 1.62 to 1.

7. The assembly according to claim 1, wherein the exterior surface of said panel is generally continuous.

8. The assembly according to claim 1, wherein the acoustic device is mounted offset from a center location of said panel.

9. The assembly according to claim 8, wherein the acoustic device is mounted offset from the center location of said panel according to the following equation:
Location=( 4/9)X, ( 3/7)Y
where,
X is the dimension of the panel along the x-axis, and Y is the dimension of the panel along the y-axis.

10. An acoustical panel assembly, comprising:
a core made of a synthetic material having a specific gravity in a range between about 0.1 and 1.4; and
an acoustic device mounted to an exterior surface of said core.

11. The assembly according to claim 10, further comprising a reinforcing material embedded within said core.

12. The assembly according to claim 11, wherein said reinforcing material comprises one of fiberglass fibers, a fiberglass mat and a combo mat.

13. The assembly according to claim 10, further comprising a cover material bonded to an opposite exterior surface of said core.

14. The assembly according to claim 10, further comprising a reinforcing material bonded to the exterior surface of said core and a cover material bonded to an opposite exterior surface of said core.

15. The assembly according to claim 10, wherein the acoustic device is mounted offset from a center location of said panel.

16. The assembly according to claim 15, wherein the acoustic device is mounted offset from the center location of said panel according to the following equation:
Location=( 4/9)X, ( 3/7)Y
where,
X is the dimension of the panel along the x-axis, and
Y is the dimension of the panel along the y-axis.

17. A method of manufacturing an acoustical panel assembly, comprising:
forming a panel having a core made of a synthetic material by one of a reaction injection molding (RIM) process, a reinforced reaction injection molding (RRIM) process, and a structural reaction molding (SRIM) process; and
mounting an acoustic device to an exterior surface of said core.

18. The method of claim 17, further comprising the step of embedding a reinforcing material within said core.

19. The method of claim 17, further comprising the step of bonding a cover material to an opposite exterior surface of said core.

20. The method of claim 17, wherein the acoustic device is mounted offset from a center location of said panel.
